(19) United States
(12) Patent Application Publication
(10) Pub. No.: US 2008/0290812 A1
(43) Pub. Date: Nov. 27, 2008

(54) Transformer Driver and Transformer Driving Method

(75) Inventors: Akira Mizutani, Saitama (JP); Yasuhide Matsuo, Saitama (JP)

Correspondence Address: GREENBLUM & BERNSTEIN, P.L.C., 1950 ROLAND CLARKE PLACE, RESTON, VA, 20191, US

(73) Assignee: TAMURA CORPORATION, Tokyo (JP)

(21) Appl. No.: 11/572,598

(22) PCT Filed: Oct. 12, 2005
(86) PCT No.: PCT/JP2005/018805

§ 371 Date: Jan. 24, 2007

(30) Foreign Application Priority Data
Oct. 13, 2004 (JP) 2004-298337

(51) Int. Cl. H05B 41/288; H02M 7/48

(52) U.S. Cl. 315/276; 363/132

(57) ABSTRACT

A transformer driver capable of making a load current constant with a simple configuration is provided. A driver 10 of the present invention applies a drive voltage Vd to the primary side of a piezoelectric transformer 11 in which a load 12 is connected to the secondary side. The angular frequency ω₀ of the drive voltage Vd is a series resonance angular frequency given by an equivalent circuit on the output side of the driver 10. With the driver 10, a load current I_{L} can be constant irrespective of the impedance Z_{L} of the load 12 with a simple configuration. Therefore, the load current I_{L} can always be constant even if the impedance Z_{L} of the load 12 varies.

### TECHNICAL FIELD

The present invention relates to a transformer such as a piezoelectric transformer which transforms AC voltage by utilizing a resonance phenomenon of a piezoelectric vibrator, and in detail, relates to a driver and a driving method thereof.

### BACKGROUND ART

A piezoelectric transformer (SOLIDFORMER) is adapted to input low voltage and output high voltage by utilizing a resonance phenomenon of a piezoelectric vibrator. The characteristics of a piezoelectric transformer are that the energy density of a piezoelectric vibrator is higher than that of an electromagnetic type. Therefore, a piezoelectric transformer can be miniaturized, so it is used for cold cathode tube lightning, liquid crystal backlight lighting, a small-size AC adapter, small-size high voltage power supply, or the like. Further, art in which cold cathode tubes are used as a liquid crystal backlight and piezoelectric transformers are used for lighting the cold cathode tubes has been known (for example, Patent Document 1)

Patent Document 1: Japanese Patent Application Laid-Open No. 10-200174

### DISCLOSURE OF THE INVENTION

### Problems to be Solved by the Invention

There is a case where a plurality of cold cathode tubes are used as a liquid crystal backlight, and a piezoelectric transformer is provided for each of the cold cathode tubes. In such a case, uneven brightness in the backlight is caused unless the tube current flowing in each cold cathode tube is made to be the same. As a method to solve it, a technique to control each tube current so as to make the current value same. With such a technique, however, a special control circuit is required, which causes a drop in efficiency due to power loss in the circuit and an increase in the manufacturing cost.

In view of the above, an object of the present invention is to provide a transformer driver and a transformer driving method, capable of making the load current constant with a simple configuration.

### Means to Solve the Problems

A transformer driver according to the present invention applies a drive voltage to the primary side of a transformer in which a load is connected to the secondary side. The frequency of the drive voltage is a series resonance frequency provided by an equivalent circuit on the output side of the driver at the time when the impedance of the load is made infinite (claim 1). In order to make the frequency of the drive voltage constant, an open control or a feedback control may be performed. Thereby, the load current can be made constant with a simple configuration.

As described above, the present inventor has found that “if the output side of a driver includes a transformer and a load, an equivalent circuit on the output side of the driver is expressed by a series resonance circuit (RLC series circuit) and a load connected in parallel with the C component of the series resonance circuit”, and “when the drive voltage of the series resonance frequency at the time when the impedance of the load is made infinite is applied to the transformer, the current flowing in the load is made constant irrespective of the impedance of the load”. The present invention has been developed based on these findings.

Further, in the driver according to the present invention, the equivalent circuit is so configured that the inductance, the resistance, the first electrostatic capacitance and the second electrostatic capacitance are connected in series, and the impedance of the load is connected to the second electrostatic capacitance in parallel. This brings the equivalent circuit in claim 1 into shape. The impedance of the load may include an inductance component or an electrostatic capacitance component besides a resistance component.

Further, in the driver according to the present invention, the second electrostatic capacitance is so configured that the electrostatic capacitance on the secondary side of the transformer and the stray capacitance of the load are connected in parallel. In this case, the load current is made constant irrespective of the impedance of the load. For example, assuming that the series resonance frequency is a series resonance angular frequency ω₀, the inductance is L, the resistance is R, the first electrostatic capacitance is C, and the second electrostatic capacitance is C_{L}, the series resonance angular frequency is given by ω₀=1/{square root over (L{CC_{L}/(C+C_{L})})} (where R<<1/ω₀C_{L}).

Further, the driver according to the present invention includes: a current phase detection unit which detects a phase of a load current flowing in the load; a voltage phase detection unit which detects a phase of the drive voltage; and a frequency controller which controls the frequency of the drive voltage such that the phase of the drive voltage detected by the voltage phase detection unit advances by 90 degrees with respect to the phase of the load current detected by the current detection unit.

When the output side of the driver includes a transformer and a load, an equivalent circuit of the output side of the driver is expressed by a series resonance circuit (RLC series circuit) and a load connected in parallel with the C component of the series resonance circuit. When the drive voltage of the series resonance frequency of the equivalent circuit, at the time when the impedance of the load is made infinite, is applied to the transformer, the load current is made constant irrespective of the impedance of the load. At this time, the load current is delayed in phase by 90 degrees with respect to the drive voltage, as described later. In other words, when the load current is delayed in phase by 90 degrees with respect to the drive voltage, the frequency of the drive voltage (hereinafter referred to as “drive frequency”) coincides with the series resonance frequency of the equivalent circuit at the time when the impedance of the load is made infinite.

On the other hand, in the case of making the drive frequency constant by an open control, strictly speaking, the characteristics of respect constituent parts of the driver and respective components of the equivalent circuit change depending on the voltage, current, temperature, time and the like, so the drive frequency and the series resonance frequency vary. Therefore, by detecting the phases of the drive voltage and the load current and controlling the drive frequency such that the phase of the drive voltage advances by 90 degrees with respect to the load current (that is, by a feedback control), it is possible to make the load current constant with high accuracy.

Further, the driver according to the present invention is so configured that the transformer is a piezoelectric transformer in the driver. The transformer may be an electromagnetic-type (winding-type) transformer, but in the case of a piezoelectric transformer, it is advantageous in making it miniaturized and light-weighted. Further, if it is a piezoelectric transformer, respective constant values (L, C, etc.) can be realized with higher accuracy than the case of an electromagnetic type.

Further, the driver according to the present invention is so configured that the load is a discharge tube. A discharge tube may be, besides a cold cathode tube (cold cathode fluorescent tube) described below, a hot cathode tube (hot cathode fluorescent tube), a mercury lamp, a sodium lamp, a metal halide lamp, neon or the like.

The discharge tube may be a cold cathode tube.

In the current-voltage characteristics of a discharge tube including a cold cathode tube, negative resistance is caused in a part thereof. The negative resistance has such a property that the voltage on the both ends of the cold cathode tube decreases as the current flowing in the cold cathode tube increases. Further, if it is considered that to an AC voltage source including a driver and a transformer, an output impedance thereof and the cold cathode tube are connected in series, the operation point of the cold cathode tube is determined from the load line thereof and the current-voltage characteristics of the cold cathode tube. However, the cold cathode tube shows negative resistance in a part, so if the output impedance of the AC voltage source is low, a plurality of operation points of the cold cathode tubes are caused. As a result, the operation of the cold cathode tube becomes unstable.

On the other hand, in the present invention, when the transformer and the driver are seen from the cold cathode tube, they serve as a constant current source. This is because the current flowing in the cold cathode tube is constant irrespective of the impedance of the cold cathode tube. Therefore, the output impedance of the AC voltage source can be regarded as almost infinite. As a result, the operation point of the cold cathode tube becomes only one, so the cold cathode tube can operate stably.

Further, in the case where a driver according to the present invention and a cold cathode tube are paired, and the backlight of a liquid crystal display is configured by combining plural pairs thereof, currents flowing in the respective cold cathode tubes can be made constant irrespective of the impedance of the respective cold cathode tubes, so uneven brightness in the backlight can be prevented.

A driving method according to the present invention is one in which the driver according to the present invention is taken as a method invention. Namely, a driving method according to the present invention is to apply a drive voltage to the primary side of a transformer in which a load is connected to the secondary side. The method may include creating an equivalent circuit including the transformer and the load, and setting a series resonance frequency provided by the equivalent circuit at the time when the impedance of the load is made infinite as a frequency of the drive voltage. The method may also include detecting the phase of a load current flowing in the load, and also detecting the phase of the drive voltage; and controlling the frequency of the drive voltage such that the detected phase of the drive voltage advances by 90 degrees with respect to the detected phase of the load current.

In other words, the present invention provides a method to find operating conditions to increase the output impedance of a piezoelectric transformer (high-voltage transformer) used for a backlight inverter. That is, driving is performed with a series resonance frequency of the secondary side of a piezoelectric transformer including stray capacitance between a high voltage terminal of the cold cathode tube mounted on the backlight house and the GND. Alternatively, an inverter is driven with a frequency which is made resonant by the stray capacitance between the high voltage terminal of the cold cathode tube mounted on a backlight house and the GND, and by the inductance component on the secondary side of the piezoelectric transformer. Thereby, the piezoelectric transformer can be made close to the constant current source, whereby deviation in the respective tube currents flowing in the cold cathode tubes can be reduced without controlling the respective tube currents, whereby it is possible to provide a backlight inverter which is highly efficient, inexpensive, and involving less uneven brightness.

Further, a transformer driver according to the present invention is a driver which applies a drive voltage to the primary side of a transformer that a load is connected to the secondary side, in which the transformer has a function as a constant current source with respect to the load, and the transformer serves as the constant current source when the drive voltage of a resonance frequency, at the time when the impedance of the load is made infinite, is applied so that the transformer generates a resonant state continuously.

According to the present invention, the voltage of a resonance frequency at the time when the impedance of the load is made infinite is applied to the primary side of the transformer. Upon being applied with the voltage of the resonance frequency, the transformer serves as a constant current source, and the output impedance of the transformer, when the transformer is seen from the load side, increases.

It is desirable that the resonance frequency be determined by an inductance component and an electrostatic capacitance component of the transformer appearing in the circuit of an ideal transformer, and by a parallel capacitance component of the stray capacitance of the load and the secondary side line capacitance of the ideal transformer. The ideal transformer is assumed in order to understand the operation of the transformer, so the operation of the ideal transformer becomes the basic operation of the actual transformer.

According to the configuration described above, when the transformer is realized as an ideal transformer, it is possible to cause a resonant state in the transformer by only using the inductance component and the electrostatic capacitance appearing as parameters of the ideal transformer and the stray capacitance of the load.

In this case, assuming that the frequency is ω, the inductance component of the transformer is L′, the electrostatic capacitance is C′, the secondary side line capacitance is C₀₂, the stray capacitance of the load is C_{L}′, and the winding ratio of the ideal transformer is ø, it is desirable that the frequency ω be expressed as follows:

$$ω = \frac{1}{\sqrt{{φ}^{2} \cdot {L}^{′} \cdot \frac{\frac{{C}^{′}}{{φ}^{2}} ( {C}_{02} + {C}_{L}^{′} )}{\frac{{C}^{′}}{{φ}^{2}} + {C}_{02} + {C}_{L}^{′}}}} \qquad [ Formula 1 ]$$

By setting the frequency of the drive voltage driving the transformer as described above, the output impedance of the transformer increases to the maximum.

Further, it is desirable to include a frequency controller which maintains a resonant state by performing a control to advance the phase of the drive voltage by 90 degrees with respect to the phase of the load current flowing in the load.

In the case where the frequency of the drive voltage is made constant by an open control, strictly speaking, the characteristics of the respective constituent parts of the driver and the transformer change depending on the voltage, current, temperature, time and the like, so the resonant state of the transformer is suppressed. Therefore, a control to advance the phase of the drive voltage by 90 degrees with respect to the phase of the load current is performed (feedback control of phase). Thereby, the resonant state of the transformer is continued, so the output impedance of the transformer, seen from the load side, keeps the maximum value.

A load driving method according to the present invention is a driving method to apply a drive voltage to the primary side of a transformer in which a load is connected to the secondary side, characterized as to operate the transformer as a constant current source by applying, to the transformer, the drive voltage of a resonance frequency at the time when the impedance of the load is made infinite.

### EFFECTS OF THE INVENTION

According to the present invention, a frequency of the drive voltage to be applied to the primary side of the transformer, in which a load is connected to the secondary side, is set as a series resonance frequency given by an equivalent circuit on the output side of the driver at the time when the impedance of the load is made infinite, whereby the load current can be made constant irrespective of the impedance of the load with a simple configuration. Therefore, the load current can always be constant even if the impedance of the load varies.

Further, by detecting the phases of the drive voltage and the load current and controlling the frequency of the drive voltage such that the phase of the drive voltage advances by 90 degrees with respect to the load current, the load current can be made constant with high accuracy even if the drive frequency and the series resonance frequency vary.

Further, since the output impedance, seen from the load side, can be made infinite even if the load shows negative resistance, the operation point of the load can be determined to only one, whereby the operation of the load can be stable.

Further, in the case where the transformer is a piezoelectric transformer and the load includes a plurality of cold cathode tubes, it is possible to realize a backlight of a liquid crystal display, which is small-sized and light weighted without involving uneven brightness.

Further, according to the present invention, a configuration in which the output impedance of the secondary side of the transformer increases without any additional component is realized, so even in the case of connecting to a plurality of loads separately, it is possible to reduce deviation in the currents flowing in the respective loads without controlling the currents flowing in the respective loads.

### BEST MODE FOR CARRYING OUT THE INVENTION

FIG. 1 shows a first embodiment of a driver according to the present invention, in which FIG. 1A is an actual circuit diagram, FIG. 1B is an equivalent circuit diagram of FIG. 1A, FIG. 1C is an equivalent circuit diagram of FIG. 1B, and FIG. 1D is a vector diagram showing the relationship between a drive voltage and a load current. Hereinafter, explanation will be given based on the drawings.

A driver 10 of the present embodiment is to apply a drive voltage Vd to the primary side of a piezoelectric transformer 11 in which a load 12 is connected to the secondary side. The angular frequency ω₀ of the drive voltage Vd is a series resonance angular frequency provided by an equivalent circuit on the output side of the driver 10 when the impedance of the load 12 is made infinite. Note that a cold cathode tube is used as the load 12.

The piezoelectric transformer 11 is one in which primary electrodes 22 and 23 and a secondary electrode 24 are provided to a piezoelectric vibrator 21, and the primary side is polarized in a thickness direction (vertical direction in FIG. 1A), and the secondary side is polarized in a length direction (horizontal direction in FIG. 1A), which are accommodated in a resin case (not shown). The primary electrodes 22 and 23 face each other over the piezoelectric vibrator 21. The piezoelectric vibrator 21 is made of piezoelectric ceramics such as PZT, and in a plate shape (rectangular parallelepiped shape). In the length direction of the piezoelectric vibrator 21, the primary electrodes 22 and 23 are provided from one end to a half of the length thereof, and the secondary electrode 24 is provided on the other end. When the drive voltage Vd of a intrinsic resonance frequency fr determined by the length dimension is inputted to the primary side, intense mechanical vibration is caused due to the inverse piezoelectric effect, and a high output voltage Vo corresponding to the vibration is outputted from the secondary side due to the piezoelectric effect. The output voltage Vo is applied to the load 12.

According to the driver 10, the load current I_{L} can be constant irrespective of the impedance Z_{L} of the load 12 with a simple configuration. Therefore, the load current I_{L} can always be constant even if the impedance Z_{L} of the load 12 varies. The reason thereof will be explained below in detail.

The actual circuit shown in FIG. 1A can be expressed by the equivalent circuit shown in FIG. 1B. In FIG. 1B, the piezoelectric transformer 11 is replaced by an ideal transformer having electrostatic capacitances C₀₁, C₀₂ and C′, inductance L′, resistance R′ and a turn ratio 1:ø, or the like. The drive voltage Vd is assumed to be a drive voltage E′. The electrostatic capacitance C_{L}′ is stray capacitance of the load 12.

The equivalent circuit in FIG. 1B can be further expressed by the equivalent circuit of FIG. 1C in which the piezoelectric transformer 11 side is seen from the load 12 side. Note that E=øE′, L=ø²L′, C=C′/ø², R=ø²R′ and C_{L}=C₀₂+C_{L}′. In the equivalent circuit of FIG. 1C, the inductance L, the resistance R, the electrostatic capacitance C₀₂ and the electrostatic capacitance C_{L} are connected in series, and the impedance Z_{L} of the load 12 is connected in parallel with the electrostatic capacitance C_{L}. The impedance Z_{L} may include an inductance component and an electrostatic capacitance component besides a resistance component. Although FIG. 1A is shown in a simple manner by omitting components and the like, it can be indicated finally by the equivalent circuit of FIG. 1C even if such components are connected.

In FIG. 1C, it is assumed that the total current outputted from the driver 10 is I, the current flowing to the electrostatic capacitance C_{L} is I_{C}, the load current flowing to the impedance Z_{L} is I_{L}. That is,

I=I_{C}+I_{L} (1)

Further, since the voltage at the both ends of Z_{L} is I_{L}Z_{L} and the voltage at the both ends of the electrostatic capacitance C_{L} is also I_{L}Z_{L},

I_{C}=jωC_{L}I_{L}Z_{L} (2)

Therefore, from the equations (1) and (2), the total current I is given as follows:

I=I_{C}+I_{L}=I_{L}(1+jωC_{L}Z_{L}) (3)

On the other hand, from the equation (3), voltage drop due to L, C, and R is given as follows:

$$\{ R + j ( ω L - 1 / ω C ) \} I = \{ R + j ( ω L - 1 / ω C ) \} {I}_{L} ( 1 + j ω {C}_{L} {Z}_{L} ) = {RI}_{L} ( 1 + j ω {C}_{L} {Z}_{L} ) + {I}_{L} j ( ω L - 1 / ω C ) ( 1 + j ω {C}_{L} {Z}_{L} ) = \{ R - ( ω L - 1 / ω C ) ω {C}_{L} {Z}_{L} \} {I}_{L} + j \{ ω {C}_{L} {Z}_{L} R + ( ω L - 1 / ω C ) \} {I}_{L} \qquad ( 4 )$$

Therefore, from the equation (4),

E={R−(ωL−1/ωC)ωC_{L}Z_{L}}I_{L}+j{ωC_{L}Z_{L}R+(ωL−1/ωC)}I_{L}+Z_{L}I_{L} (5)

Therefore, from the equation (5), the load current I_{L} is given as follows:

I_{L}=E/[{R+Z_{L}−(ωL−1/ωC)ωC_{L}Z_{L}}+j{ωC_{L}Z_{L}R+(ωL−1/ωC)}] (6)

Here, it is assumed that

ω=1/{square root over (L{CC_{L}/(C+C_{L})})}=ω₀ (7)

The frequency ω₀ is a series resonance angular frequency of a series resonance circuit consisting of L, R, C and C_{L} when the impedance Z_{L} is made infinite in FIG. 1C. In this case,

(ωL−1/ωC)=1/ω₀C_{L} (8)

Therefore, by assigning the equations (7) and (8) to the equation (6),

I_{L}|_{ω=ω0}=E/{R+j(ω₀C_{L}Z_{L}R+1/ω₀C_{L})} (9)

is established. Since R<<1/ω₀C_{L} generally,

I_{L}|_{ω=ω0}≈E/j(1/ω₀C_{L})=−jω₀C_{L}·E (10)

is established.

Therefore, when the angular frequency of the drive voltage E is given by the equation (7), the load current I_{L} is made constant irrespective of the impedance Z_{L} of the load 12, which is obvious from the equation (10). At this time, the phase of the load current I_{L} is delayed from the drive voltage E by 90 degrees, as shown in FIG. 1D.

FIG. 2 shows an effect of the driver of FIG. 1, in which FIG. 2A is an equivalent circuit diagram, and FIG. 2B is a current-voltage characteristic chart of a cold cathode tube. Hereinafter, explanation will be given based on FIGS. 1 and 2.

Here, the load 12 in FIG. 1A is referred to as a cold cathode tube 12. In FIG. 2A, the driver 10 and the piezoelectric transformer 11 in FIG. 1A are replaced with an AC voltage source 13 and its output impedance Z_{O}. Therefore, the output impedance Z_{O} and the cold cathode tube 12 are connected in series with the AC voltage source 13.

Assuming that the both end voltage of the cold cathode tube 12 is V_{L}, the load current flowing to the cold cathode tube 12 is I_{L}, and the output voltage of the AC voltage source 13 is V_{O}, the load line is given by the following equation:

V_{L}=−Z_{O}I_{L}+V_{O} (11)

On the other hand, in the cold cathode tube 12, negative resistance appears in a part of the current-voltage characteristics as shown in FIG. 2B. The negative resistance has such a characteristic that the both end voltage V_{L} decreases as the load current I_{L} increases.

Now, in FIG. 2B, you want to set the operation point of the cold cathode tube 12 to P(I_{P}, V_{P}). However, if the impedance Z_{O} is small, the tilt of the load line becomes small, so an operation point P′ is also caused besides the operation point P. As a result, a plurality of operation points exist, so operation of the cold cathode tube 12 becomes unstable.

On the other hand, in the present embodiment, when the AC voltage source 13 side is seen from the cold cathode tube 12, the AC voltage source 13 side is a constant current source. This is because the load current I_{L} flowing to the cold cathode tube 12 is made constant irrespective of the impedance Z_{L} of the cold cathode tube 12. Therefore, the output impedance Z_{O} of the AC voltage source 13 can be regarded as almost infinite. Consequently, the tilt of the load line becomes large, so the operation point of the cold cathode tube 12 becomes P only, whereby the cold cathode tube 12 operates stably.

FIG. 3 is a block diagram showing a second embodiment of a driver according to the present invention. FIG. 4A is a circuit diagram showing an example of a −45° shift circuit in FIG. 3, and FIG. 4B is a circuit diagram showing an example of a switching circuit in FIG. 3. Hereinafter, explanation will be given based on these drawings. However, same parts in FIG. 3 as those shown in FIG. 1 are denoted by the same reference numerals, so their explanations are omitted.

A driver 30 of the present embodiment includes a current phase detection circuit 31, −45° shift circuits 32 and 33, a D-F/F (D Flip-flop) 34, an integrator 35, a VCO (voltage control oscillator) 36, a switching circuit 37, an LPF (low-pass filter) 38 and the like.

The current phase detection circuit 31 consists of, for example, a resistor inserted between the cold cathode tube 12 and a GND terminal, and outputs a phase signal “a” having the same phase as the load current I_{L}.

Each of the −45° shift circuits 32 and 33 turns the phase of the phase signal “a” from the current phase detection circuit 31 by −45 degrees, that is, −90 degrees in total. Since the −45° shifted circuits 32 and 33 have the same configuration, explanation will be given for the −45° shift circuit 32 based on FIG. 4A. The −45° shift circuit 32 is so configured that a buffer circuit 323 is connected to the output side of an integrating circuit consisting of a resistor 321 and a capacitor 322. Assuming that the resistance of the resistor 321 is R₁, the electrostatic capacitance of the capacitor 322 is C₁, and the angular frequency of the load current I_{L} is ω, respective numerical values are selected so as to satisfy the relationship of ω=1/(R₁C₁).

In this case, since the output voltage Vo₁ of the −45° shift circuit 32 can be approximated by the following equation, the phase is delayed from the input voltage Vi₁ of the −45° shift circuit 32 by 45 degrees.

Vo₁=(1/2−j/2)Vi (12)

Strictly speaking, when the angular frequency ω changes, the relationship of ω=1/(R₁C₁) cannot be established any more, so an error is caused in the phase rotation amount. However, the actual accuracy of the angular frequency ω is about ±0.5%, so an error in the phase rotation amount in the −45° shift circuit 32 does not matter.

The D-F/F 34 is a typical one having a D input terminal, a CLK input terminal and a Q output terminal, which stores the state of the D input terminal with a rise of the CLK input signal. That is, if the D input terminal is at H level, when the CLK input terminal is changed from L level to H level, the Q output terminal becomes H level. In contrast, if the D input terminal is at L level, when the CLK input terminal is changed from L level to H level, the Q output terminal becomes L level.

The integrator 35 integrates the differential voltage between the Q output signal “c” of the D-F/F 34 and the reference voltage Vref. The reference voltage Vref is set to a value which is almost intermediate between the H level voltage and the L level voltage of the Q output signal “c”. When the duty ratio of the Q output signal “c” becomes almost 50%, the output voltage “d” of the integrator 35 is made constant with respect to the time.

The VCO 36 has a function of varying the frequency value of an output signal corresponding to the voltage value of an input signal. Specifically, the VCO 36 generates a frequency signal “e” having a frequency corresponding to the output voltage “d” of the integrator 35.

The switching circuit 37 is turned on/off by being urged by the frequency signal “e” from the VCO 36 to thereby apply the drive voltage Vd to the piezoelectric transformer 11. For example, as shown in FIG. 4B, the switching circuit 37 is a typical full-bridge circuit consisting of transistors 371 to 374. The transistor 371 is a p-channel power MOSFET, which is turned on when the inversion signal “/e” of the frequency signal “e” from the VOC 36 is at L level, and is turned off when it is at H level. The transistor 372 is an n-channel power MOSFET, which is turned on when the inversion signal “/e” of the frequency signal “e” from the VCO 36 is at H level, and is turned off when it is at L level. The transistor 373 is a p-channel power MOSFET, which is turned off when the frequency signal “e” from the VCO 36 is at H level, and is turned on when it is at L level. The transistor 374 is an n-channel power MOSFET, which is turned on when the frequency signal “e” from the VCO 36 is at H level, and is turned off when it is at L level. Therefore, when the transistors 372 and 373 are turned on from the off-state and the transistors 371 and 374 are turned off from the on-state, the drive voltage Vd(=2Vcc) is applied to the piezoelectric transformer 11. Therefore, the frequency signal “e” and the drive voltage Vd are different in phase by 180 degrees. Note that the full-bridge circuit shown in FIG. 4B is just an example, so a pull-push circuit, for example, may be used instead of a full-bridge circuit.

The LPF 38 consists of a coil 375 shown in FIG. 4B for example, which removes higher harmonic wave components of tertiary or more included in the drive voltage Vd so as to transmit the fundamental wave of the drive voltage Vd.

FIG. 5 is a timing chart showing the operation of the D-F/F in FIG. 3. FIG. 6 is a graph showing the drive frequency-output current characteristics of the piezoelectric transformer in FIG. 3. Hereinafter, operation of the driver 30 will be explained based on FIGS. 3 to 6.

If the output side of the driver 30 consists of the piezoelectric transformer 11 and the cold cathode tube 12, the equivalent circuit on the output side of the driver 30 is expressed by a series resonance circuit (RLC series circuit) and the cold cathode tube 12 connected in parallel with C component of the series resonance circuit. Then, when the drive voltage Vd of the series resonance frequency ω₀/2π thereof is applied to the piezoelectric transformer 11, the load current I_{L} of the cold cathode tube 12 is made constant irrespective of the impedance of the cold cathode tube 12. At this time, the load current I_{L} is delayed in phase by 90 degrees to the drive voltage Vd. That is, when the phase of the load current I_{L} is delayed by 90 degrees to the drive voltage Vd, the drive frequency coincides with the series resonance frequency ω₀/2π of the equivalent circuit.

On the other hand, strictly speaking, in the case where the drive frequency is made constant by an open control, the characteristics of the respective constituent parts of the driver 30 and respective components of the equivalent circuit change depending on voltage, current, temperature, time and the like, so the drive frequency and series resonance frequency vary. Therefore, by detecting the phases of the drive voltage Vd and the load current I_{L} and controlling the frequency of the drive voltage Vd so as to advance the phase of the drive voltage Vd by 90 degrees with respect to the load current I_{L} (that is, by a feedback control), the load current I_{L} can be made constant with high accuracy.

Explanation will be given in more detail. First, the current phase detection circuit 31 outputs a phase signal “a” having the same phase as that of the load current I_{L}. The phase signal “a” becomes an output signal “a′” in the −45° shift circuit 32, and further, becomes an output signal “b” in the −45° shift circuit 33. Thereby, the output signal “b” is delayed in phase from the phase signal “a” by 90 degrees, so the phase is inversed with respect to the drive voltage Vd.

The output signal “b” is inputted to the CLK input terminal of the D-F/F 34. On the other hand, the frequency signal “e” outputted from the VCO 36 is inputted to the D input terminal of the D-F/F 34 through a conductor 39. Since the frequency signal “e” is inversed in phase with respect to the drive voltage Vd, the output signal “b” and the frequency signal “e” should have the same phase normally. However, if the output signal “b” and the frequency signal “e” are different in phase due to any reason, the D-F/F 34 and the like operate as follows.

When the output signal “b” is delayed in phase from the frequency signal “e”, the Q output signal becomes H level as shown in FIG. 5, so the output voltage “d” of the integrator 35 rises, whereby the frequency of the frequency signal “e” of the VCO 36 rises as shown in FIG. 6. As a result, the phase of the output signal “b” advances. In contrast, when the output signal “b” advances in phase from the frequency signal “e”, the Q output signal becomes L level as shown in FIG. 5, so the output voltage “d” of the integrator 35 drops, whereby the frequency of the frequency signal “e” of the VCO 36 drops as shown in FIG. 6. As a result, the phase of the output signal “b” is delayed.

As described above, the driver 30 detects the phases of the drive voltage Vd and the load current I_{L} and controls the frequency of the drive voltage Vd such that the phase of the drive voltage Vd advances by 90 degrees with respect to the load current I_{L}.

Further, a “current phase detection unit”, a “voltage phase detection unit”, and a “frequency controller” described in claims correspond to the “current phase detection circuit 31”, the “conductor 39” and the “driver 30 and other constituent elements”, respectively.

Note that the present invention is not limited to the first and second embodiments of course. For example, instead of a piezoelectric transformer, an electromagnetic transformer may be used. Instead of a cold cathode tube, a load having load resistance may be used for example, or another general load may be used.

In the embodiments above, explanation has been given by focusing on the frequency of a drive voltage to be applied to the primary side of a piezoelectric transformer. Next, an embodiment in which the present invention is described from the point of functional aspects of a piezoelectric transformer will be explained as another embodiment of the present invention. This embodiment will be explained based on FIGS. 1 to 6.

As shown in FIG. 1, the present embodiment is one in which the drive voltage Vd is applied to the primary side of the transformer 11 in which the load 12 is connected to the secondary side by the driver 10 as the basic configuration, and the transformer 11 serves as the constant current source to the load 12. The transformer 11 serves as a constant current source when it is applied with the drive voltage Vd of the resonance frequency at the time when the impedance of the load 12 is made infinite so as to generate a resonant state continuously.

Next, a case in which the piezoelectric transformer 11 is used as the transformer and a cold cathode tube 21 is used as the load will be explained specifically. In order to make the basic operation of the present embodiment clear, the actual circuit shown in FIG. 1A is expressed as a circuit of an ideal transformer, in which loss is zero, shown in FIG. 1B.

The piezoelectric transformer 11 is so configured that primary electrodes 22 and 23 are formed on opposite faces of a half of a piezoelectric vibrator 21 in a rectangle plate shape, and a secondary electrode 24 is formed on an end face of the opposite side, and the primary electrode 22 and 23 side is polarized in a thickness direction (vertical direction in FIG. 1A), and the secondary side is polarized in a length direction (horizontal direction in FIG. 1A). The piezoelectric transformer 11 is accommodated in a resin case (not shown). The primary electrodes 22 and 23 face each other over the piezoelectric vibrator 21. The piezoelectric vibrator 21 is made of piezoelectric ceramics such as PZT, and in a rectangle plate shape. In the length direction of the piezoelectric vibrator 21, the primary electrodes 22 and 23 are provided from one end to a half of the length, and the secondary electrode 24 is provided on the other end. When the drive voltage Vd of an intrinsic resonance frequency fr determined by the length dimension is inputted to the primary electrodes 22 and 23 of the piezoelectric transformer 11 on the primary side, intense mechanical vibration is caused due to the inverse piezoelectric effect of the piezoelectric vibrator 21, whereby a high output voltage Vo corresponding to the vibration thereof is outputted to the secondary electrode 24 of the piezoelectric transformer 11 due to the piezoelectric effect. The output voltage Vo is applied to the load 12.

When the actual piezoelectric transformer 11 shown in FIG. 1A is expressed as a circuit of an ideal transformer, a series circuit of an inductance component L′, an electrostatic capacitance component C′ and a resonance component R′, and an line capacitance C₀₁ appear on the primary side of the piezoelectric transformer 11 as shown in FIG. 1B. On the secondary side of the piezoelectric transformer 11, a line capacitance C₀₂ appears. Further, the cold cathode tube 12 mounted on the backlight house is expressed as an equivalent parallel circuit of stray capacitance C_{L}′ and a resistance component Z_{L} existing between the high pressure terminal and the GND terminal of the cold cathode tube 12. Note that the resistance component Z_{L} of the cold cathode tube 12 as a load may include electrostatic capacitance in addition to a pure resistance component, so it is defined as the impedance Z_{L} of the cold cathode tube 12, and in the specification, the resistance component Z_{L} of the cold cathode tube 12 is used as the impedance Z_{L}.

The stray capacitance C_{L}′ and the impedance Z_{L} of the cold cathode tube 12 appear in parallel with the line capacitance C₀₂ of the piezoelectric transformer 11 appearing on the secondary side of the ideal transformer. Further, the drive voltage of the driver 10, applied to the primary side of the piezoelectric transformer 11, is indicated by E. Further, the winding ratio of the primary and secondary of the ideal transformer 11 is set to 1:ø. Note that although there is nothing corresponding to the winding of a winding-type transformer in the actual piezoelectric transformer 11, the voltage on the primary side is changed to the voltage of the secondary side even in a piezoelectric transformer, so a winding ratio is used.

The present embodiment uses a resonance phenomenon of an inductance component and a line capacitance appearing on the secondary side of the ideal transformer shown in FIG. 1B and stray capacitance of the cold cathode tube 12. Therefore, an equivalent circuit shown in FIG. 1C in which the primary side of the ideal transformer shown in FIG. 1B is converted to the primary side, that is, parameter of the ideal transformer is secondary-converted, will be considered.

The equivalent circuit shown in FIG. 1C is formed of a series circuit of an inductance component L₂, the electrostatic capacitance C₂ and the resistance component R₂, which are secondary converted, and a circuit of the parallel capacitance C_{L2} of the line capacitance C₀₂ on the secondary side of the ideal transformer and the stray capacitance C_{L} of the cold cathode tube 12 connected in parallel. The inductor L, the electrostatic capacitance C, the resistance R and the parallel capacitance C_{L}, which are secondary-converted parameters, are expressed as follows. That is, E=øE′, L=ø²L′, C=C′/ø, R=ø²R′, and C_{L}=C₀₂+C_{L}′.

In the present embodiment, the drive voltage E of the resonance frequency causing resonance by the inductance component L, the electrostatic capacitance C, and the parallel capacitance C_{L} appearing on the secondary side of the piezoelectric transformer 11 shown in FIG. 1C is applied to the primary side of the piezoelectric transformer 11. The resonance frequency ω₀ at this time is indicated as follows:

$$ω = \frac{1}{\sqrt{L \cdot \begin{matrix}C \cdot {C}_{L} \\ C + {C}_{L}\end{matrix}}} \qquad [ Formula 2 ]$$

(12)

At this time, when the load current I_{L} flowing to the cold cathode tube 12 is calculated, it is expressed as follows:

$${I}_{L} = \frac{E}{\begin{matrix}\{ \frac{R}{ω {C}_{L}} - {R}_{L} ( ω L - \frac{1}{ω C} - \frac{1}{ω {C}_{L}} ) \} ω {C}_{L} + \\ j ω {C}_{L} ( {RR}_{L} + \frac{L}{{C}_{L}} - \frac{1}{{ω}^{2} {CC}_{L}} )\end{matrix}} \qquad [ Formula 3 ]$$

(13)

When the equation (12) is assigned to the equation (13),

$${I}_{L} {\vert}_{ω = {ω}_{0}} = \frac{E}{R + j ( {ω}_{0} {C}_{L} {RR}_{L} + \frac{1}{{ω}_{0} {C}_{L}} )} \qquad [ Formula 4 ]$$

(14)

Generally,

$$R << \frac{1}{{ω}_{0} {C}_{L}} \qquad [ Formula 5 ]$$

Therefore, the equation (14) is expressed as follows:

$${I}_{L} {\vert}_{ω = {ω}_{0}} ≅ \frac{E}{j \frac{1}{{ω}_{0} {C}_{L}}} = - j {ω}_{0} {C}_{L} \cdot E \qquad [ Formula 6 ]$$

(15)

Therefore, it has no relationship with the impedance Z_{L} of the cold cathode tube, so it serves as a constant current source with respect to the impedance Z_{L} of the cold cathode tube.

Therefore, in the present embodiment, in a driver which applies a drive voltage to the primary side of the transformer 11 in which the load 12 is connected to the secondary side, the transformer 11 has a function as a constant current source with respect to the load 12, and the transformer 11 is so configured as to serve as the constant current source when the drive voltage Vd of the resonance frequency ω₀, at the time when the impedance Z_{L} of the load 12 is made infinite, is applied so that the transformer 11 generates a resonant state continuously.

As described above, the resonance frequency ω₀ is determined by the inductance component and the electrostatic capacitance component of the transformer appearing on the circuit of the ideal transformer, and by the parallel capacitance component of the stray capacitance of the load and the secondary side line capacitance of the ideal transformer. In this case, assuming that the resonance frequency is ω, the inductance component of the transformer is L′, the electrostatic capacitance is C′, the secondary side line capacitance is C₀₂, the stray capacitance of the load is C_{L}′, and the winding ratio of the ideal transformer is ø,

the resonance frequency ω₀ is set as follows:

$$ω = \frac{1}{\sqrt{{φ}^{2} \cdot {L}^{′} \cdot \frac{\frac{{C}^{′}}{{φ}^{2}} ( {C}_{02} + {C}_{L}^{′} )}{\frac{{C}^{′}}{{φ}^{2}} + {C}_{02} + {C}_{L}^{′}}}} \qquad [ Formula 7 ]$$

When the resonance frequency ω₀ is indicated by a secondary converted parameter, it becomes the equation (12).

In the explanation above, although the case where the inductance component L′, the electrostatic capacitance C′ and the resistance component R′ are shown by a series circuit in the equivalent circuit shown in FIG. 1C in which the ideal transformer shown in FIG. 1B is secondary converted has been described, the present invention is no limited to this configuration. The present invention may be so configured that, according to the Thevenin's theorem, it is expressed as a parallel circuit of composite capacitance of the electrostatic capacitance C′, the line capacitance C₀₂ and the stray capacitance CL′, and the inductance component L′, and in a parallel resonant state in the parallel circuit, the drive voltage Vd of the resonance frequency ω₀, at the time when the impedance Z_{L} of the load 12 is made infinite, is applied to the transformer 11 so as to cause a resonant state in the transformer 11 continuously, whereby the transformer 11 serves as a constant current source.

FIG. 2 shows an effect of the driver of FIG. 1, in which FIG. 2A is an equivalent circuit diagram, and FIG. 2B is a current-voltage characteristic chart of a cold cathode tube. Hereinafter, explanation will be given based on FIGS. 1 and 2.

In FIG. 2A, the driver 10 and the piezoelectric transformer 11 in FIG. 1A are replaced with the AC voltage source 13 and its output impedance Z_{O}. Therefore, the output impedance Z_{O} and the cold cathode tube 12 are connected to the AC voltage source 13 in series.

Assuming that the both end voltage of the cold cathode tube 12 is V_{L}, the load current flowing to the cold cathode tube 12 is I_{L}, the output voltage of the AC voltage source 13 is V_{O}, the load line is given by the following equation:

V_{L}=−Z_{O}I_{L}+V_{O} (16)

As shown in FIG. 2B, in the cold cathode tube 12, negative resistance appears in a part of the current-voltage characteristics thereof. The negative resistance has such a characteristic that the both end voltage V_{L} decreases as the load current I_{L} increases.

In FIG. 2B, you want to set the operation point of the cold cathode tube 12 to P(I_{P}, V_{P}). However, if the impedance Z_{O} is small, the tilt of the load line becomes small, whereby an operation point P′ is also caused besides the operation point P. Then, a plurality of operation points exist, so the operation of the cold cathode tube 12 becomes unstable. As shown in FIG. 1D, the phase of the load current I_{L} is delayed from the drive voltage E by 90 degrees. In the present embodiment, the resonant state is maintained by performing a control to advance the phase of the drive voltage by 90 degrees with respect to the phase of the load current flowing to the cold cathode tube 12. This will be explained in detail by using a specific example.

The driver of the present embodiment shown in FIG. 3 is described with the reference numeral 30. As shown in FIG. 3, the driver 30 includes a current phase detection circuit 31, −45° shift circuits 32 and 33, a D-F/F (D flip-flop) 34, an integrator 35, a VCO (voltage control oscillator) 36, a switching circuit 37, and an LPF (low-pass filter) 38.

The current phase detection circuit 31 consists of a resistor inserted between the cold cathode tube 12 and a GND terminal for example, and outputs a phase signal “a” having the same phase as the load current I_{L}.

Each of the −45° shift circuits 32 and 33 turns the phase of the phase signal “a” from the current phase detection circuit 31 by −45 degrees, so −90 degrees in total. Since the −45° shift circuits 32 and 33 have the same configuration, explanation will be given for the −45° shift circuit 32 based on FIG. 4A. The −45° shift circuit 32 is so configured that a buffer circuit 323 is connected to the output side of an integration circuit consisting of a resistor 321 and a capacitor 322. Assuming that the resistance of the resistor 321 is R₁, the electrostatic capacitance of the capacitor 322 is C₁, and the angular frequency of the load current I_{L} is ω, respective numerical values are set so as to satisfy the relationship of ω=1/(R₁C₁).

At this time, since the output voltage Vo₁ of the −45° shift circuit 32 can be approximated by the following equation, the phase is delayed from the input voltage Vi₁ of the −45° shift circuit 32 by 45 degrees.

Vo₁=(1/2−j/2)Vi₁ (16)

Strictly speaking, when the angular frequency ω varies, the relationship of ω=1/(R₁C₁) cannot be established any more, so an error is caused in the phase turning amount. However, since the actual accuracy of the angular frequency ω is about ±0.5%, an error in the phase rotation amount in the −45° shift circuit 32 does not matter.

The D-F/F 34 is a typical one having a D input terminal, a CLK input terminal and a Q output terminal, in which the state of a D input signal is stored with a rise of a CLK input signal. That is, if the D input terminal is at H level, when the CLK input terminal is changed from L level to H level, the Q output terminal becomes H level. In contrast, if the D input terminal is at L level, when the CLK input terminal is changed from L level to H level, the Q output terminal becomes L level.

The integrator 35 integrates a differential voltage between a Q output signal “e” of the D-F/F 34 and the reference voltage Vref. The reference voltage Vref is set to a value almost intermediate between the H level voltage and the L level voltage of the Q output signal “e”. When the duty ratio of the Q output signal “e” becomes almost 50%, the output voltage “d” of the integrator 35 is made constant with respect to the time.

The VCO 36 has a function of changing the frequency value of an output signal corresponding to the voltage value of an input signal. Specifically, it generates a frequency signal “e” having a frequency corresponding to the output voltage “d” of the integrator 35.

The switching circuit 37 is turned on/off by being urged by the frequency signal “e” from the VCO 36 to thereby apply the drive voltage Vd to the piezoelectric transformer 11. For example, as shown in FIG. 4B, the switching circuit 37 is a typical full-bridge circuit consisting of transistors 371 to 374. The transistor 371 is a p-channel power MOSFET, which is turned on when the inverse signal “/e” of the frequency signal “e” from the VCO 36 is at L level, and is turned off when it is at H level. The transistor 372 is an n-channel power MOSFET, which is turned on when the inverse signal “/e” of the frequency signal “e” from the VCO 36 is at H level, and is turned off when it is at L level. The transistor 373 is a p-channel power MOSFET, which is turned off when the frequency signal “e” from the VCO 36 is at H level, and is turned on when it is at L level. The transistor 374 is an n-channel power MOSFET, which is turned on when the frequency signal “e” from the VCO 36 is at H level, and is turned off when it is at L level. Therefore, when the transistors 372 and 373 are turned on from the off state, and the transistors 371 and 374 are turned off from the on state, the drive voltage Vd(=2Vcc) is applied to the piezoelectric transformer 11. Therefore, the frequency signal “e” and the drive voltage Vd are different in phase by 180 degrees. Note that the full-bridge circuit shown in FIG. 4B is just an example, and a pull-push circuit may be used for example, instead of a full-bridge circuit.

The LPF 38 consists of a coil 375 shown in FIG. 4B for example, which removes higher harmonic components of tertiary or more included in the drive voltage Vd to thereby transmit the fundamental wave of the drive voltage Vd.

FIG. 5 is a timing chart showing the operation of the D-F/F in FIG. 3. FIG. 6 is a graph showing drive frequency-output current characteristics of the piezoelectric transformer in FIG. 3. Hereinafter, operation of the driver 30 will be explained based on FIGS. 3 to 6.

In the case where the piezoelectric transformer 11 and the cold cathode tube 12 are connected to the output side of the driver 30, an equivalent circuit in which an ideal transformer is secondary-converted as described above is expressed as shown in FIG. 1C. When the drive voltage Vd of the resonance frequency ω₀/2π is applied to the primary side of the piezoelectric transformer 11, the load current I_{L} of the cold cathode tube 12 is made constant irrespective of the impedance of the cold cathode tube 12. At this time, the load current I_{L} is delayed by 90 degrees in phase with respect to the drive voltage Vd. That is, when the phase of the load current I_{L} is delayed by 90 degrees with respect to the drive voltage Vd, the drive frequency coincides with the series resonance frequency ω₀/2π of the equivalent circuit.

Strictly speaking, in the case of making the drive frequency constant by an open control, the characteristics of respective constituent parts of the driver 30 and respective components of the equivalent circuit change depending on voltage, current, temperature, time and the like, so the resonance frequency varies. Therefore, by detecting the phases of the drive voltage Vd and the load current I_{L} and controlling the frequency of the drive voltage Vd so as to advance the phase of the drive voltage Vd by 90 degrees with respect to the load current I_{L} (that is, by a feedback control), the load current I_{L} can be made constant with high accuracy.

Explanation will be given in more detail. First, the current phase detection circuit 31 outputs a phase signal “a” having the same phase as the load current I_{L}. The phase signal “a” becomes an output signal “a′” in the −45° shift circuit 32, and further, becomes an output signal “b” in the −45° shift circuit 33. Thereby, the output signal “b” is delayed in phase from the phase signal “a” by 90 degrees, so the phase is inversed with respect to the drive voltage Vd.

The output signal “b” is inputted to the CLK input terminal of the D-F/F 34. On the other hand, the frequency signal “e” outputted from the VCO 36 is inputted to the D input terminal of the D-F/F 34 via a conductor 39. Since the phase of the frequency signal “e” is inversed with respect to the drive voltage Vd, the output signal “b” and the frequency signal “e” should have the same phase normally. However, if the output signal “b” and the frequency signal “e” are different in phase due to any reason, the D-F/F 34 and the like operate as follows.

When the output signal “b” is delayed in phase from the frequency signal “e”, the Q output signal becomes H level as shown in FIG. 5, so the output voltage “d” of the integrator 35 rises, whereby the frequency of the frequency signal “e” of the VCO 36 rises as shown in FIG. 6. As a result, the phase of the output signal “b” advances. In contrast, if the phase of the output signal “b” advances from the frequency signal “e”, the Q output signal becomes L level as shown in FIG. 5, so the output voltage “d” of the integrator 35 drops, whereby the frequency of the frequency signal “e” of the VCO 36 drops as shown in FIG. 6. As a result, the phase of the output signal “b” is delayed.

As described above, the driver 30 detects the phases of the drive voltage Vd and the load current I_{L}, and controls the frequency of the drive voltage Vd such that the phase of the drive voltage Vd advances by 90 degrees with respect to the load current I_{L}.

Here, the frequency controller, which maintains the resonant state by performing a control to advance the phase of the drive voltage by 90 degrees with respect to the phase of the load current flowing in the load, includes the current phase detection circuit 31, the −45° shift circuits 32 and 33, the D-F/F 34, the integrator 35, the VCO 36 and the switching circuit 37.

Note that although a piezoelectric transformer is used as the transformer 11 in the embodiment described above, it is not limited to this. The present invention can be applied similarly in the case of using a winding-type transformer using a ballast capacitor or a reactor on the secondary side, instead of the piezoelectric transformer. In the case of using a piezoelectric transformer as the transformer, it is advantageous in making it miniaturized and light-weighted. Further, in the case of a piezoelectric transformer, respective constant values (L, C, etc.) can be realized more accurately than the case of an electromagnetic type.

Further, although a cold cathode tube is used as the load 12, it is not limited to this. Instead of the cold cathode tube, a hot cathode tube (hot cathode fluorescent tube), a mercury lamp, a sodium lamp, a metal halide lamp, or neon may be used.

### INDUSTRIAL APPLICABILITY

As described above, the present invention is so configured that the secondary side output impedance of a transformer increases without any additional component. Therefore, even in the case of connecting to a plurality of loads separately, it is possible to reduce deviation in currents flowing respective loads without controlling the currents flowing the respective loads.

### BRIEF DESCRIPTION OF THE DRAWINGS

FIG. 1A-1D show a first embodiment of a driver according to the present invention, in which FIG. 1A is an actual circuit diagram, FIG. 1B is an equivalent circuit diagram of FIG. 1A, FIG. 1C is an equivalent circuit diagram of FIG. 1B, and FIG. 1D is a vector diagram showing the relationship between a drive voltage and a load current.

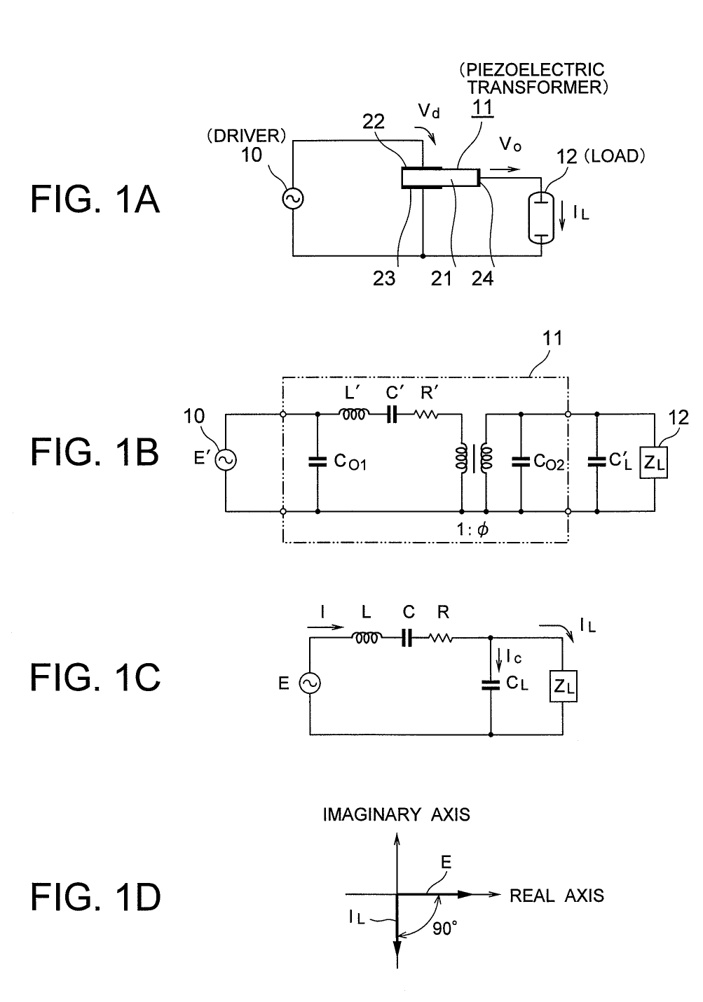

FIG. 2A, 2B show an effect of the driver of FIG. 1, in which FIG. 2A is an equivalent circuit diagram, and FIG. 2B is a current-voltage characteristic chart of a cold cathode tube.

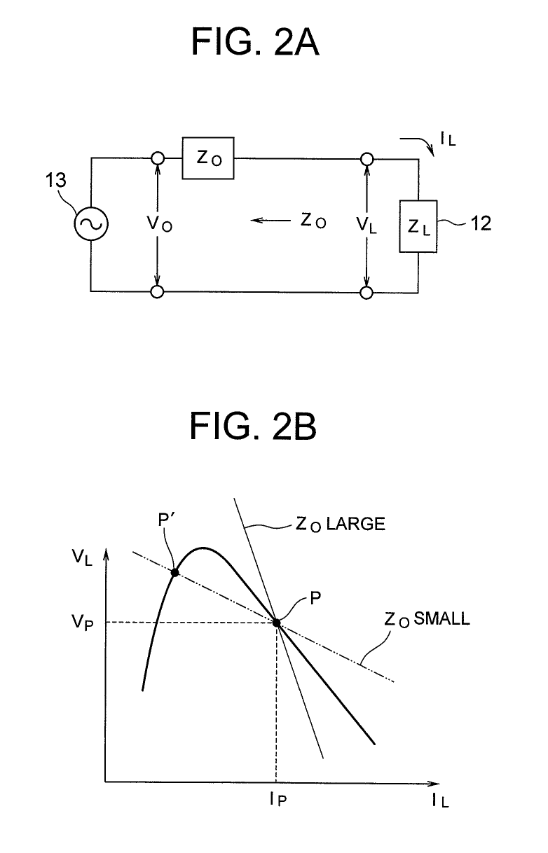

FIG. 3 is a block diagram showing a second embodiment of a driver according to the present invention.

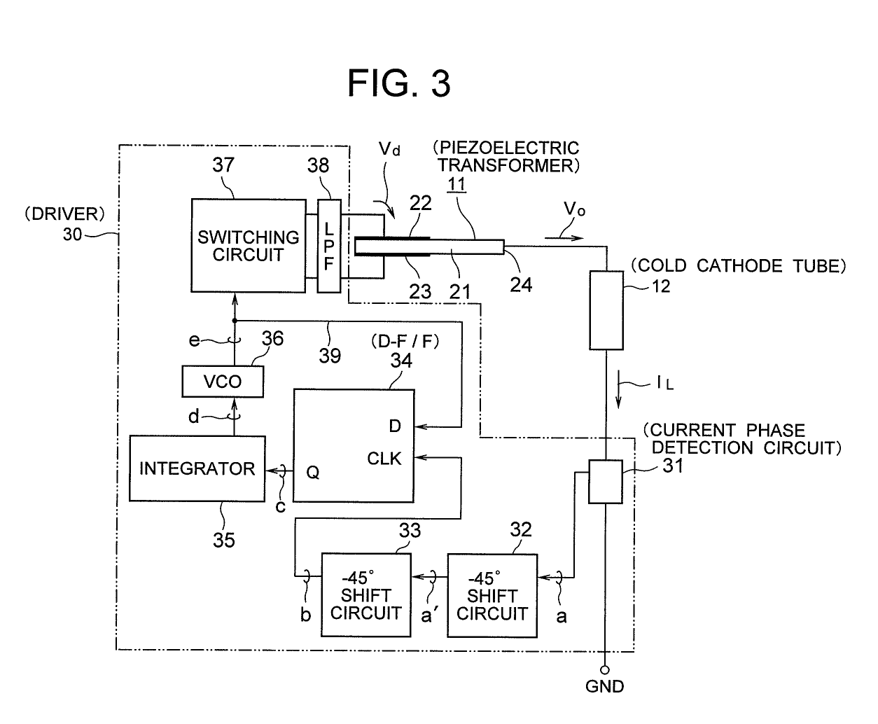

FIG. 4A is a circuit diagram showing an example of the −45° shift circuit in FIG. 3, and FIG. 4B is a circuit diagram showing an example of the switching circuit in FIG. 3.

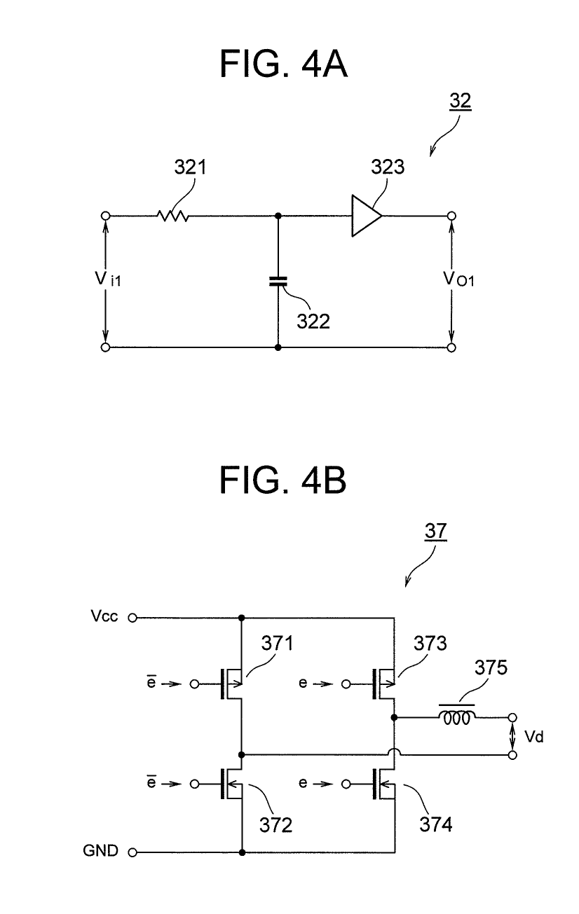

FIG. 5 is a timing chart showing the operation of the D-F/F in FIG. 3.

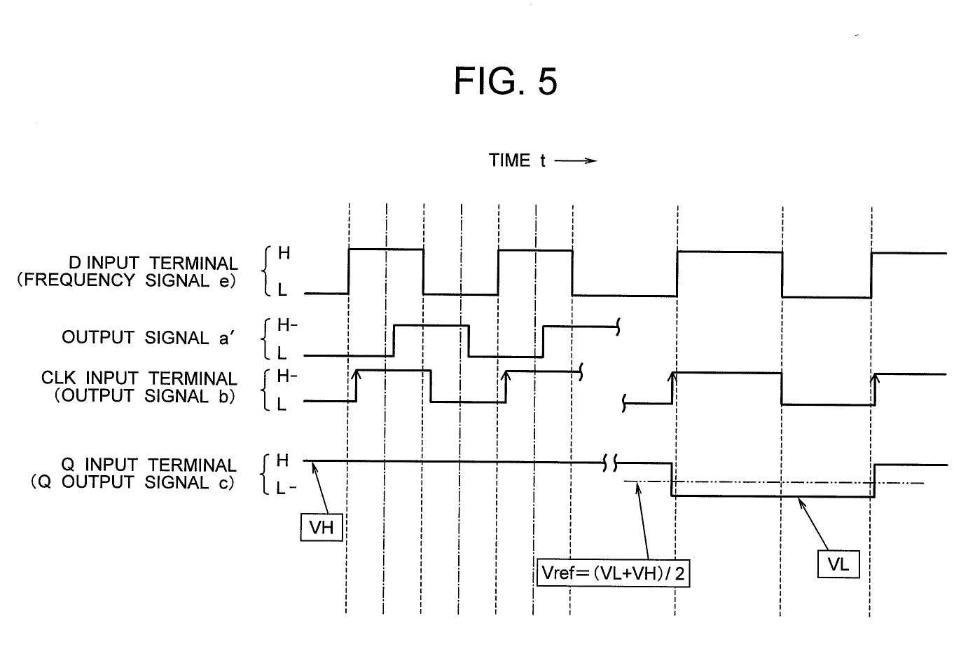

FIG. 6 is a graph showing drive frequency-output current characteristics of the piezoelectric transformer in FIG. 3.

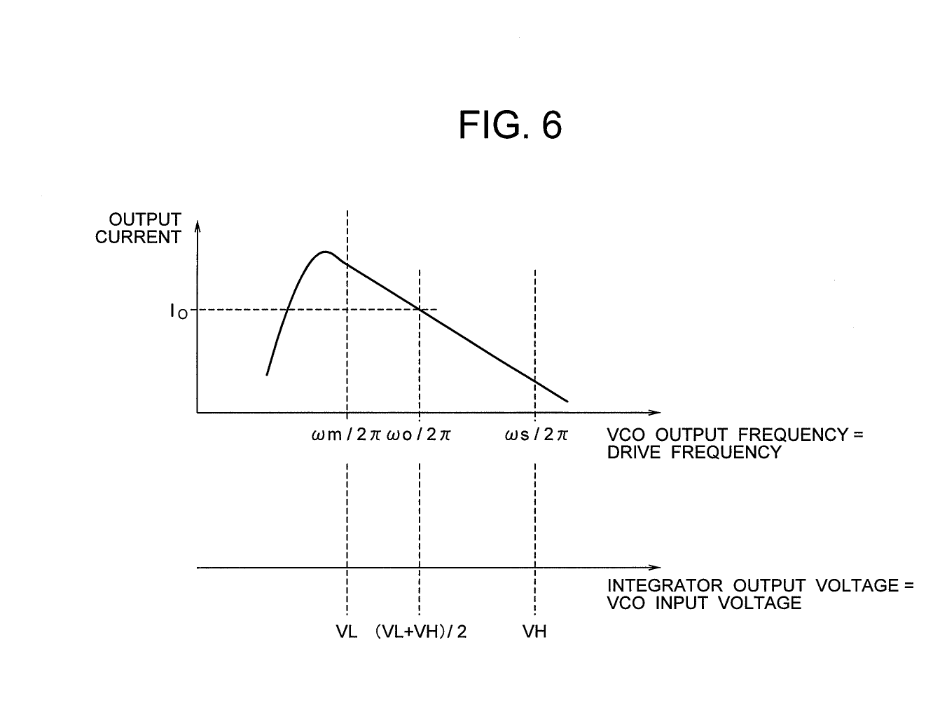

### DESCRIPTION OF REFERENCE NUMERALS

10, 30 driver
11 piezoelectric transformer
12 load (cold cathode tube)
21 piezoelectric vibrator
22, 23 primary electrode
24 secondary electrode
31 current phase detection circuit
32, 33 −45° shift circuit
34 D-F/F
35 integrator
36 VCO
37 switching circuit
38 LPF

1. A transformer driver which applies a drive voltage to a primary side of a transformer in which a load is connected to a secondary side, wherein a frequency of the drive voltage is a series resonance frequency provided by an equivalent circuit on an output side of the driver at a time when impedance of the load is made infinite.

2. The transformer driver according to claim 1, wherein the equivalent circuit is so configured that inductance, resistance, first electrostatic capacitance and second electrostatic capacitance are connected in series, and the impedance of the load is connected to the second electrostatic capacitance in parallel.

3. The transformer driver according to claim 2, wherein the second electrostatic capacitance is so configured that electrostatic capacitance on the secondary side of the transformer and stray capacitance of the load are connected in parallel.

4. The transformer driver according to claim 3, wherein assuming that the series resonance frequency is a series resonance angular frequency ω0, the inductance is L, the resistance is R, the first electrostatic capacitance is C, and the second electrostatic capacitance is CL, the series resonance angular frequency is given by:
ω₀=1/{square root over (L{CC_{L}/(C+C_{L})})} (where R<<1/ω0CL)

5. A transformer driver which applies a drive voltage to a primary side of a transformer in which a load is connected to a secondary side, comprising:
a current phase detection unit which detects a phase of a load current flowing in the load;
a voltage phase detection unit which detects a phase of the drive voltage; and
a frequency controller which controls a frequency of the drive voltage such that the phase of the drive voltage detected by the voltage phase detection unit advances by 90 degrees with respect to the phase of the load current detected by the current detection unit.

6. The transformer driver according to claim 1, wherein the transformer is a piezoelectric transformer.

7. The transformer driver according to claim 1, wherein the load is a discharge tube.

8. The transformer driver according to claim 7, wherein the discharge tube is a cold cathode tube.

9. A transformer driving method to apply a drive voltage to a primary side of a transformer in which a load is connected to a secondary side, comprising:
creating an equivalent circuit including the transformer and the load, and setting a series resonance frequency, provided by the equivalent circuit at a time when impedance of the load is made infinite, as a frequency of the drive voltage.

10. A transformer driving method to apply a drive voltage to a primary side of a transformer in which a load is connected to a secondary side, comprising:
detecting a phase of a load current flowing in the load, and detecting a phase of the drive voltage; and
controlling a frequency of the drive voltage such that a detected phase of the drive voltage advances by 90 degrees with respect to a detected phase of the load current.

11. A transformer driver which applies a drive voltage to a primary side of a transformer in which a load is connected to a secondary side, wherein
the transformer has a function as a constant current source with respect to the load, and
the transformer serves as the constant current source when the drive voltage of a resonance frequency, at a time when impedance of the load is made infinite, is applied so that the transformer generates a resonant state continuously.

12. The transformer driver according to claim 11, wherein the resonance frequency is determined by an inductance component and an electrostatic capacitance component of the transformer appearing in a circuit of an ideal transformer, and by a parallel capacitance component of stray capacitance of the load and secondary side line capacitance of the ideal transformer.

13. The transformer driver according to claim 12, wherein assuming that the resonance frequency is ω, the inductance component of the transformer is L′, the electrostatic capacitance is C′, the secondary side line capacitance is C02, the stray capacitance of the load is CL′, and a winding ratio of the ideal transformer is ø, the resonance frequency ø is given by:
$$ω = \frac{1}{\sqrt{{φ}^{2} \cdot {L}^{′} \cdot \frac{\frac{{C}^{′}}{{φ}^{2}} ( {C}_{02} + {C}_{L}^{′} )}{\frac{{C}^{′}}{{φ}^{2}} + {C}_{02} + {C}_{L}^{′}}}} \qquad [ Formula 1 ]$$

14. The transformer driver according to claim 11, including a frequency controller which maintains a resonant state by performing a control to advance a phase of the drive voltage by 90 degrees with respect to a phase of the load current flowing in the load.

15. A transformer driving method to apply a drive voltage to a primary side of a transformer in which a load is connected to a secondary side, comprising:
applying, to the transformer, the drive voltage of a resonance frequency at a time when impedance of the load is made infinite to thereby operate the transformer as the constant current source.

16. The transformer driving method according to claim 15, further comprising,
setting the resonance frequency by an inductance component and an electrostatic capacitance component of the transformer appearing in a circuit of an ideal transformer, and by a parallel capacitance component of stray capacitance of the load and secondary side line capacitance of the ideal transformer to thereby apply the drive voltage to the transformer.

17. The transformer driving method according to claim 15, further comprising,
performing a control to advance a phase of the drive voltage by 90 degrees with respect to a phase of a load current flowing in the load to thereby maintain a resonant state caused in the transformer.
